(19) United States
(12) Patent Application Publication
(10) Pub. No.: US 2011/0047409 A1
(43) Pub. Date: Feb. 24, 2011

(54) STORAGE DEVICE SUPPORTING AUTO BACKUP FUNCTION

(75) Inventors: Jung Wook HUR, Suwon-si (KR); Hae Jung LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/844,391

(22) Filed: Jul. 27, 2010

(30) Foreign Application Priority Data
Aug. 18, 2009 (KR) 10-2009-0076150

(51) Int. Cl. G06F 12/16; G06F 11/20

(52) U.S. Cl. 714/6; 711/162; 711/E12.103; 714/E11.084

(57) ABSTRACT

A storage device having an automatic backup function, which is connected to a host apparatus to store user data, is provided. The storage device includes a storage medium which stores the user data, and a controller which controls data writing and reading of the storage medium. The controller backs up at least a portion of the user data stored in the storage medium in an available region of the storage medium when the storage device is in an idle mode.

### CROSS-REFERENCE TO RELATED APPLICATION

This application claims priority under from Korean Patent Application No. 10-2009-0076150, filed on Aug. 18, 2009, in the Korean Intellectual Property Office, the disclosure of which is incorporated herein in its entirety by reference.

### BACKGROUND

Exemplary embodiments relate to a memory apparatus, and more particularly, to a storage device providing a function to automatically backup data in the storage device without a command from a host or a user.

In a relate art used data backup and restoration method, data stored in a storage device is backed up and the backup data is restored, by using a function provided by an operation system (OS). Also, a user may install an application/program for performing backup at a host, for example, a computer, and the data stored in the storage device is partially or totally copied and compressed, for backup, by using the installed application/program. The backup data is restored when necessary.

When the data backup is performed by the above backup method, since a portion of the storage device is always assigned for the storage of backup data, the capacity of the storage device assigned for the backup is large and actual usability is low.

### SUMMARY

One or more exemplary embodiments provide a storage device which performs data backup in a predetermined method in the storage device without a command from an operation system (OS) or a user.

One or more exemplary embodiments also provide a storage device which performs data backup by dynamically searching for a empty space in the storage apparatus, instead of having a fixed space assigned as a backup space, thereby improving usability of the space of the storage apparatus.

One or more exemplary embodiments also provide a storage device which automatically performs data backup even when an OS or a user does not perform data backup. Thus, when a file is damaged, a backup file is automatically searched for and read out so that reliability of the storage device may be improved.

According to an aspect of an exemplary embodiment, there is provided a storage device having an automatic backup function which is connected to a host apparatus to store user data, the storage device including a storage medium which stores the user data, and a controller which controls data writing and reading of the storage medium, wherein when the storage device is in an idle mode, the controller backs up at least a portion of the user data stored in the storage medium in an available region of the storage medium.

The controller may search for a location where at least a portion of the user data is backed up and back up the at least the portion of the user data at a searched location.

The controller may divide the storage medium into a plurality of blocks. When the at least the portion of the user data is written to a first block of the plurality of blocks, the controller may determine the first block to be a target backup block to be backed up and back up data of the first block in a second block of the available region. The controller may store matching information indicating that the second block is a backup block of the first block in the storage medium or at least one of memories provided in the storage medium.

The controller may receive from the host a read command to read the first block. When a read error is generated in the first block, the controller may provide the host with backup data stored in the second block based on the matching information. When a write command to write second user data to the second block is received, the controller may write the second user data to the second block.

The controller may set that the first block has the higher backup priority among target backup blocks. When at least a partial area of the first block is determined to be a defect, the controller may reassign the at least a partial area to another area of the storage medium and copy a backup area corresponding to the at least the partial area of the second block to the other area that is reassigned.

The controller may determine whether to backup at least a portion of the user data in the available region, or erase at least a portion of the user data that is backed up, based on a type of data of the at least the portion of the user data.

According to an aspect of another exemplary embodiment, there is provided a storage device having an automatic backup function which is connected to a host apparatus to store user data, the storage device including a storage medium which stores the user data, and a controller which controls data writing and reading of the storage medium, wherein the controller divides the storage medium into a plurality of blocks, and when at least a portion of the user data is written to a first block of the plurality of blocks, the controller backs up data of the first block in a second block that is an available region of the storage device.

### BRIEF DESCRIPTION OF THE DRAWINGS

The above and/or other aspects will be more clearly understood from the following detailed description of exemplary embodiments taken in conjunction with the accompanying drawings in which:

FIG. 1 is a schematic block diagram showing the structure of a storage device supporting an automatic backup function, according to an exemplary embodiment according to an exemplary embodiment;

FIG. 2 is a block diagram for explaining a case in which the storage device of FIG. 1 is a hard disk drive;

FIGS. 3 through 8 illustrate a backup process performed by the storage device of FIG. 1 according to an exemplary embodiment;

FIG. 9 is a flowchart for explaining the backup process of the storage device of FIG. 1 according to an exemplary embodiment; and

FIG. 10 is a flowchart for explaining a data restoration process performed by the storage device of FIG. 1 according to an exemplary embodiment.

### DETAILED DESCRIPTION OF EXEMPLARY EMBODIMENTS

Exemplary embodiments will be described in detail with reference to the attached drawings. Like reference numerals in the drawings denote like elements.

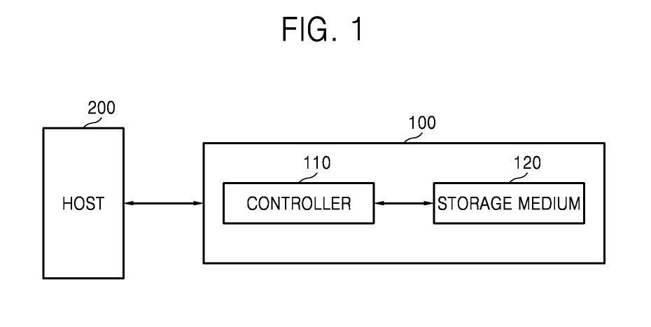

FIG. 1 is a schematic block diagram showing the structure of a storage device supporting an automatic backup function, according to an exemplary embodiment. Referring to FIG. 1, the storage device (or apparatus) 100 supporting an automatic backup function includes a controller 110 and a storage medium 120. The storage device 100 having its own firmware may include various types of storage (or memory) devices that are known in the related art.

The storage device 100 supporting an automatic backup function may be employed for a large capacity storage device such as a hard disk drive (HDD), a solid state disk (SSD), or a flash memory. Although, in the present specification, the storage device 100 supporting an automatic backup function is an HDD, the inventive concept is not limited thereto.

The controller 110 of the storage device 100 receives a write command to write data or a read command to read the data recorded in the storage medium 120 of the storage device 100 supporting an automatic backup function, from a host 200, for example, a computer. Then, the controller 110 may control the storage medium 120 to perform an operation corresponding to the received command or predetermined devices to perform a data write/read operation with respect to the storage medium 120.

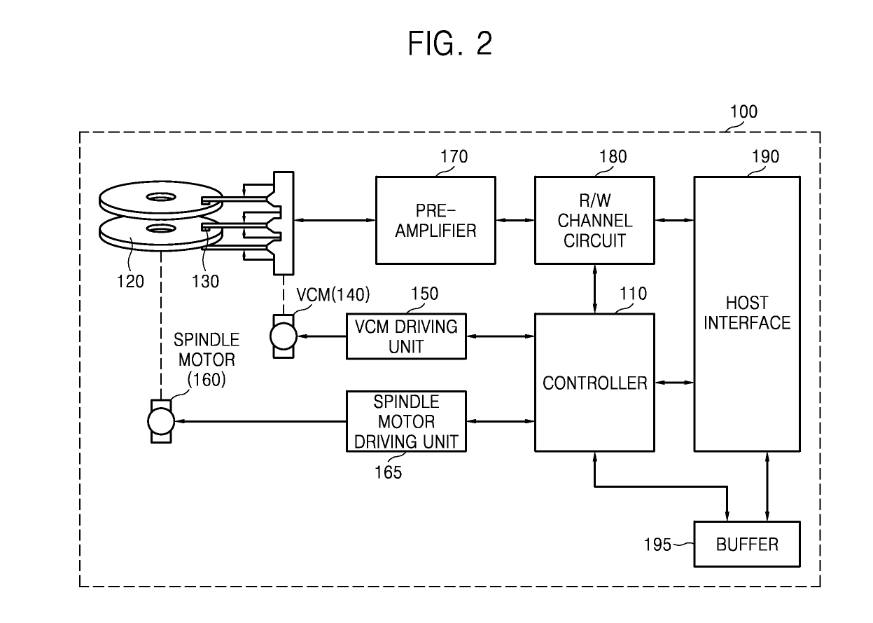

FIG. 2 is a block diagram for explaining a case in which the storage device of FIG. 1 is an HDD. Referring to FIG. 2, the storage device 100 supporting an automatic backup function may further include a voice coil motor (VCM) 140, a VCM driving unit 150, a spindle motor 160, a spindle motor driving unit 165, a magnetic head 130, a pre-amplifier 170, a read/write (R/W) channel circuit 180, a host interface 190, and a buffer 195, in addition to the controller 110 and the storage medium 120. The controller 110 controls the VCM 140, the VCM driving unit 150, the spindle motor 160, the spindle motor driving unit 165, the magnetic head 130, the pre-amplifier 170, the R/W channel circuit 180, the host interface 190, and the buffer 195.

The controller 110 performs a variety of controls needed for driving the storage device 100 supporting an automatic backup function. For example, to perform a data write operation to the storage medium 120, for example, a disk 120, the controller 110 outputs data to be written to the magnetic head 130 via the R/W channel circuit 180 and the pre-amplifier 170, and controls the location on the storage medium 120 where the data is to be written by controlling the VCM driving unit 150 and the spindle motor 160. A predetermined firmware is utilized by the controller 110 to perform the above-described operation or other various operations. The firmware may be included in the controller 110 or stored in a predetermined memory (not shown), for example, a random access memory (RAM) or NOR flash memory, connected to the controller 110. The firmware may include predetermined codes.

Referring back to FIG. 1, the storage device 100 supporting an automatic backup function performs data communications with the host 200 and an operation corresponding to the OS of the host 200 and/or a user command. When the above operation is completed, the storage device 100 supporting an automatic backup function enters an idle mode.

Herein, the idle mode signifies a time during which the storage device 100 substantially performs no operation after the operation to perform the command received from the user and/or the OS is completed, regardless of the operation of the storage device 100 supporting an automatic backup function. Thus, the storage device 100 may backup the user data recorded on the storage medium 120 in an empty (or blank) space, that is, an available region, of the storage medium 120 by a predetermined method using the controller 110 and firmware driven by the controller 110, as described later. As a result, data backup may be performed without deterioration of the performance of the storage device 100 supporting an automatic backup function or without hindrance to the operation desired by the user.

Herein, the user data includes not only data that the user records on the storage medium 120 via the host 200, but also all meaningful data stored in the storage medium 120 such as the OS needed to operate the host 200. Also, the available region includes a region of the storage medium 120 where data may be newly written. The available region does not necessarily include a blank space where no data is written. In an actual HDD, when data is erased, not only is the data erased from the storage medium 120, but also location information for pointing the data is erased so that the data may be overwritten.

The backup method of the storage device 100 supporting an automatic backup function will be described below. The storage device 100 supporting an automatic backup function may automatically backup user data without being noticed by the user. Thus, a region where backup data of the user data is stored may be actually recognized by the user as an available region. When a write command to write a predetermined data at a location where the backup data is stored is performed according to a command from the user and/or OS, the storage device 100 may give up the backup data and write the predetermined data. As a result, according to the storage device 100, a backup location of data may dynamically vary.

When the controller 110 tries to backup part or all of the user data, a location of the storage medium 120 where backup may be actually performed is searched for and a backup is performed at the searched location. Thus, since the backup is not performed at a particular fixed space, usability of space may be improved.

The controller 110 may divide the storage medium 120 into predetermined units of blocks and perform backup for each block. That is, as the backup is performed in the idle mode in units of blocks, even when the idle mode is short in duration, the backup may be partially performed. Thus, even when the available region of data is not physically continuous on the storage medium 120, the backup may be efficiently performed.

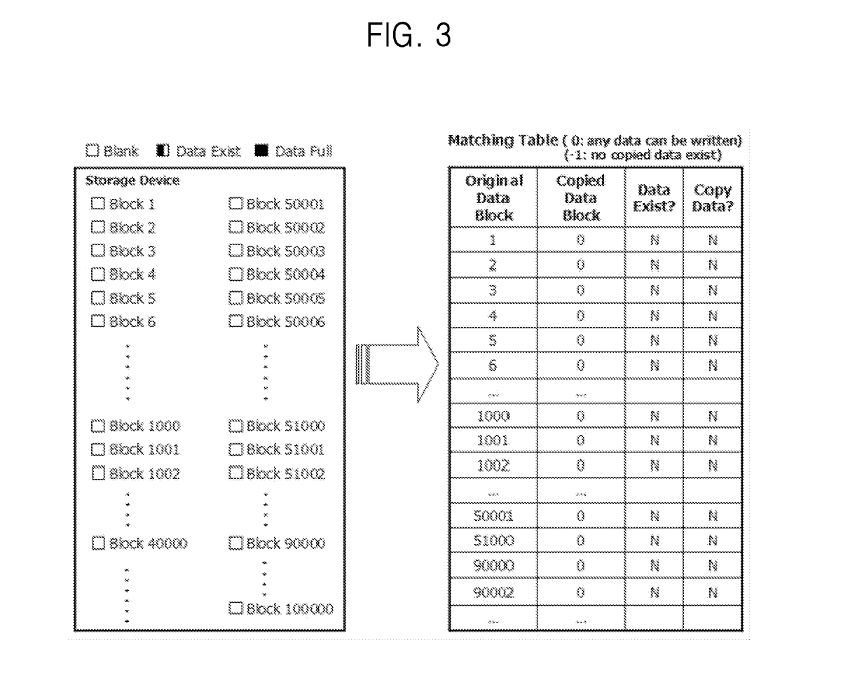

FIGS. 3 through 8 illustrate a backup process performed by the storage device of FIG. 1 according to an exemplary embodiments. Referring to first FIG. 3, when the storage device 100 supporting an automatic backup function is an HDD, the capacity of the storage medium 120 may be expressed by a logical block address (LBA). The overall LBA may be divided into a predetermined unit, that is, a plurality of blocks. In FIG. 3, the storage medium 120 is in an initial state in which no user data exists in the whole disk, and the whole storage medium 120 is divided into tens of thousands of blocks.

Also, the controller 110 may maintain matching information indicating the relationship between a block where the original data exists and a block where the original data is copied, that is, a backup block, in the storage medium 120, for example, a maintenance cylinder of the HDD, or a separate memory, for example, a DRAM, an SRAM, or buffer, of the storage device 100 supporting an automatic backup function. The matching information may be maintained as a matching table that is a predetermined table form, as illustrated in FIG. 3, but the inventive concept is not limited thereto. Also, for efficiency of backup, the controller 110 may further maintain information on whether data exists in each block and/or each block is a backup block or the original block.

In FIG. 3, since no user data is written to the storage medium 120, information of “0” may be written to all backup blocks, or copied data blocks, corresponding to the blocks. Also, the matching table may further include a data exist field (Data Exist?) indicating whether data is stored in each block and a backup existence field (Copy Data?) indicating whether each block is a backup block.

When the user data is written to at least a portion of any one of the blocks, the controller 110 may determine the block to be a target backup block.

When at least a portion of user data is written to any one block, it may signify that not only a case of a block in which data is fully stored but also a case of a block in which data is partially stored becomes a target backup block according to an exemplary embodiment. In other words, backup may be performed either when a block is full of data or when a block is partially filled with data. The controller 110 may use a variety of methods to determine whether a block is fully or partially filled with data. For example, in the case of an HDD, a host command output from the host 200, that is, information about a write address included in a write command, may be stored in the maintenance cylinder. Also, whether a block is a target backup block may be determined based on the write address.

When a block is determined to be a target backup block, the controller 110 may backup the target backup block in a predetermined order of priority or sequentially in the idle mode of the storage device 100 supporting an automatic backup function.

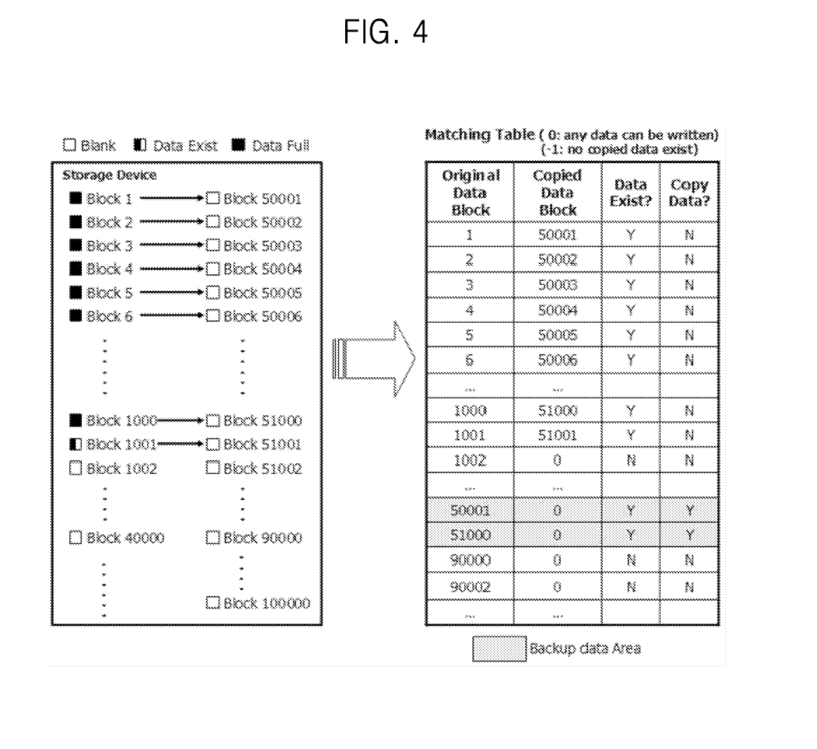

FIG. 4 illustrates an example in which user data is written from Block 1 to Block 1001 and blocks from Block 50001 are set to be backup blocks. According to an exemplary embodiment, the backup block of Block 1 may be Block 2 or the backup blocks may not be continuous unlike those illustrated in FIG. 4. To search for a backup block to backup a target backup block, the controller 110 may search for a backup block, to which backup may be actually performed, in the available region, that is, the blocks where backup may be performed, by searching for a block having the lowest number of the block to be used for backup, that is, blocks belonging to the available region, or using a variety of search algorithms, for example, sequential search or binary search.

For example, as illustrated in FIG. 4, when the user data is sequentially written from Block 1 to Block 1001, the controller 110 may write information indicating that data exist from Block 1 to Block 1001 in the data exist field Data Exist? of the matching table. Also, when the controller 110 searches for or sets the target backup block of each of Block 1 to Block 1001 to be Block 50001 to Block 51001, respectfully, the controller 110 may copy Block 1 to Block 1001 in the target backup blocks, that is, Block 50001 to Block 51001. Then, as illustrated in FIG. 4, information indicating that data exists may be written to the data exist field (Data Exist?) corresponding to Block 50001 to Block 51001 and information indicating that the block is a backup block may be written to the backup existence field (Copy Data?).

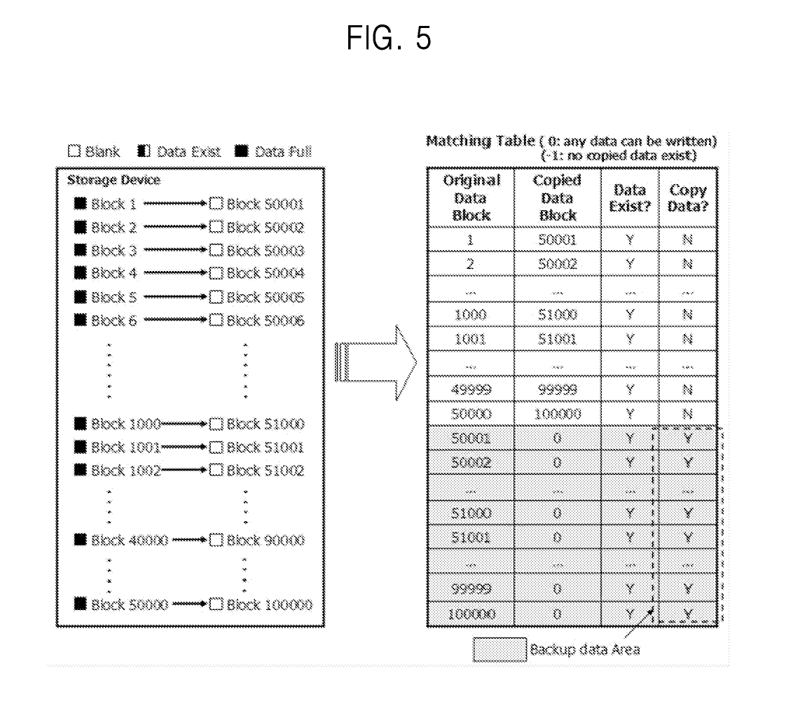

FIG. 5 illustrates a case in which backup is performed to the maximum in the above backup method. That is, when the user data is written to half of the total capacity of the storage medium 120, that is, half of the overall blocks, all user data may be backed up.

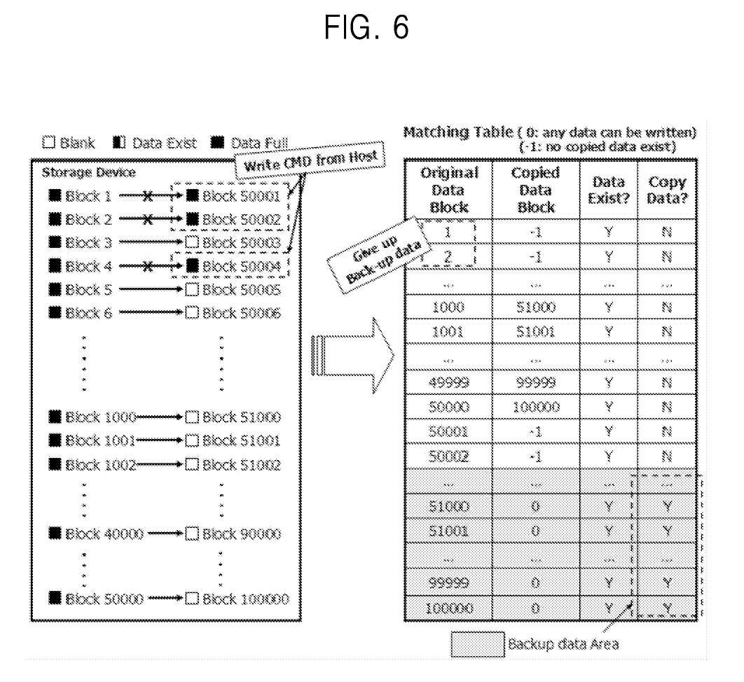

FIG. 6 illustrates a case in which user data is newly written in the state of FIG. 5. Referring to FIG. 6, when the controller 110 receives a write command to write new user data in Blocks 50001, 50002, and 50004 from the host 200 in the state of FIG. 5, the controller 110 may replace the backup data in the backup blocks, that is, Blocks 50001, 50002, and 50004, by writing the new user data therein. Then, the controller 110 writes information, for example, “−1”, indicating that Blocks 1, 2, and 4 have no backup blocks in the matching table. Also, since Blocks 50001, 50002, and 50004 in which the new user data is written have no available region for performing backup, the controller 110 may write information, for example, “−1”, indicating that backup blocks do not exist. Also, although Blocks 50001, 50002, and 50004 are backup blocks in FIG. 5, Blocks 50001, 50002, and 50004 are the original data in FIG. 6. Accordingly, the controller 110 may write information, for example, “N”, indicating that the block is not a backup block.

That is, as illustrated in FIG. 6, since the storage device 100 supporting an automatic backup function uses a blank space for backup regardless of the command from the user or the host 200, the host 200 may actually recognize the backup block as a blank space. Thus, according to the inventive concept, the backup of all user data is not guaranteed. However, as the capacity of a storage device increases, most space of the storage device may be blank so that the technical concept of the present inventive concept may be sufficiently used. Also, when the user data is over the half of the capacity of the storage medium 120, the user data may not be backed up so long as compression is not used for the backup. Thus, the effect of backup is not deteriorated.

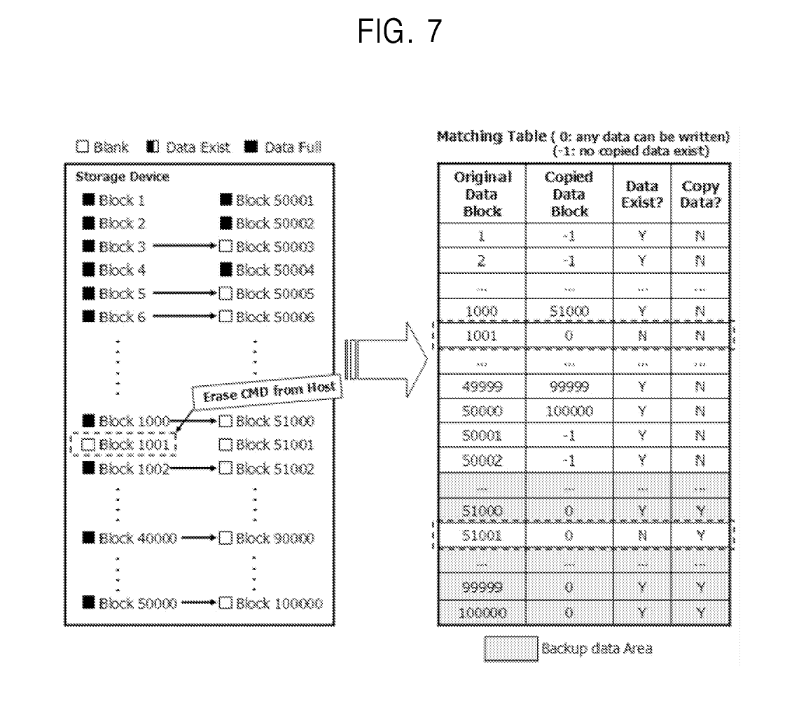

FIG. 7 illustrates a case when the original data is erased in the state of FIG. 6. Referring to FIG. 7, when a host command to erase the data of Block 1001 is received in the state of FIG. 6, the controller 110 may erase the data of Block 1001, write information indicating that no data exists in Block 1001, for example, “N”, to the data exist field (Data Exist?), and erase information about the backup block of the Block 1001, that is, information about Block 51001, from the Copied Data Block field. Also, the controller 110 may write information indicating that no data exists in Block 51001.

Then, as illustrated in FIG. 7, if a target backup block that is a block that should be backed up is not backed up, separate information, for example, “−1” or “0”, instead of the identification number of the backup block, may be written as information about the backup block, that is, the Copied Data Block field.

The controller 110 may set the order of priority to perform backup to the target backup blocks, by writing different information, for example, “−1” or “0”, as the information about the backup block of the target backup block, for example, Block 1 and 2 or Blocks 1001 and 51001.

When “0” is written as the information about a backup block (the Copied Data Block field), any data may be written to a corresponding block. For example, when Block 1 or Block 2 that is backed up and then the backup block is erased as user data is written to the backup block, that is, Block 50001 or 50002, of Block 1 or Block 2, “−1” may be written as the information about the backup block, wherein “−1” may indicate one of the target backup blocks that is first to be backed up.

When new data like Block 1001 or Block 51001 is written, no available region for backup is left. Thus, when new data is written to Block 1001 or Block 51001, “−2” may be written as the information about the backup block, wherein “−2” may indicate one of the target backup blocks that is second to be backed up. Accordingly, since the controller 110 sets the order of priority of the target backup blocks according to a predetermined standard, there is an effect of providing an efficient backup algorithm and a priority order suitable for a predetermined standard even when the backup space is insufficient.

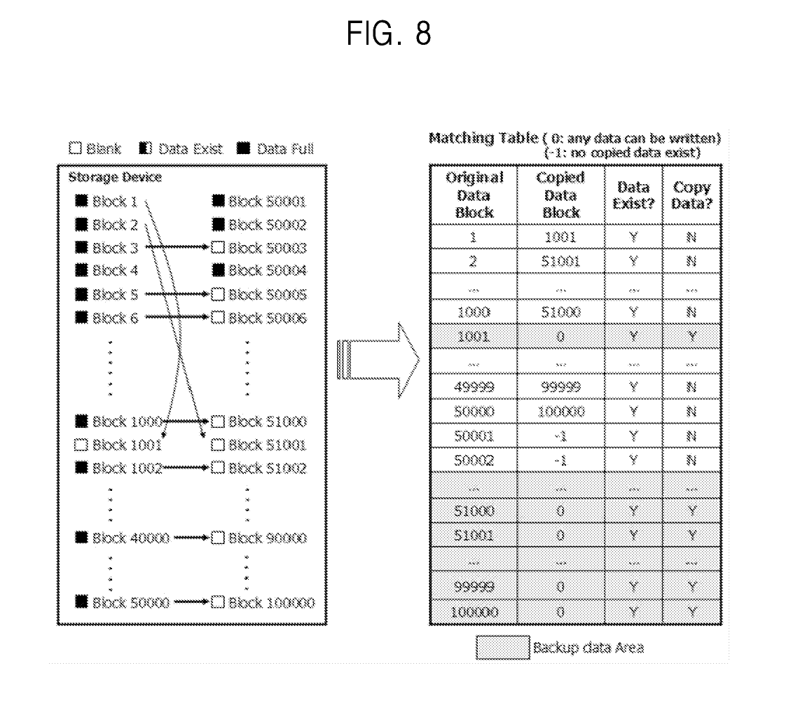

Referring to FIG. 8, when the storage device 100 supporting an automatic backup function enters the idle mode from the state in which new user data is not written to Block 1001 or Block 51001 in the state of FIG. 7, the controller 110 may backup a target backup block having the highest priority, for example, Block 1 or 2, and the backup block of Block 1 or Block 2 may be Block 1001 or 51001. Then, the controller 110 may generate a matching table as illustrated in FIG. 8.

According to the above-described storage device 100 supporting an automatic backup function, when the controller 110 receives a command from the host 200 to read data in an area corresponding to a particular block or a portion of the particular block, the controller 110 may perform a data read operation. The controller 110 may transmit the read data to the host 200. When an error is generated in the data transmitted to the host 200, the controller 110 may determine the backup block of the data based on the information included in the matching table, that is, matching information, and provide the host 200 with at least a portion of the information stored in the backup block corresponding to the data. The particular block where the original data is located is overwritten by the information stored in the backup block so that the data may be automatically restored. According to an exemplary embodiment, the controller 110 may determine whether a read error is generated. In such a case, the data may be restored in a similar process.

When at least a partial area of a particular block is determined to be defective, the controller 110 may reassign the at least a partial area to other area of the storage medium 120 and copy data of the backup area corresponding to the at least a partial area of the backup block of the particular block to the other area that is reassigned. The determination of a defective area by the controller 110 may be performed in a variety of methods according to an exemplary embodiment. For example, a particular area may be determined to be defective when a read error is repeatedly generated or over a predetermined number. According to the storage device 100 supporting an automatic backup function, when a defect is generated in the storage medium 120, the storage device 100 automatically reassign a defect area and restores the data backed up in the reassigned area, thereby improving reliability of the storage medium 120.

When a space for backup is insufficient, the storage device 100 supporting an automatic backup function may erase the backup data of the data according to the type of data to secure the backup space in the storage medium 120. Also, the storage device 100 may not perform backup by previously determining whether to perform backup according to the type of the original data. For example, when the user data is contents such as video or music and the importance of backup of the contents is determined to be low, the controller 110 may recognize the type of user data based on the file name of the user data or using other various methods. When the user data is a predetermined type of data, the controller 110 may not perform backup or erase the backup block of the user data even when the user data is backed up, thereby increasing the backup space. Such operation is performed in the idle mode of the storage device 100 supporting an automatic backup function. When a space over a predetermined rate is used from the total capacity, the controller 110 may determine that the backup space is insufficient.

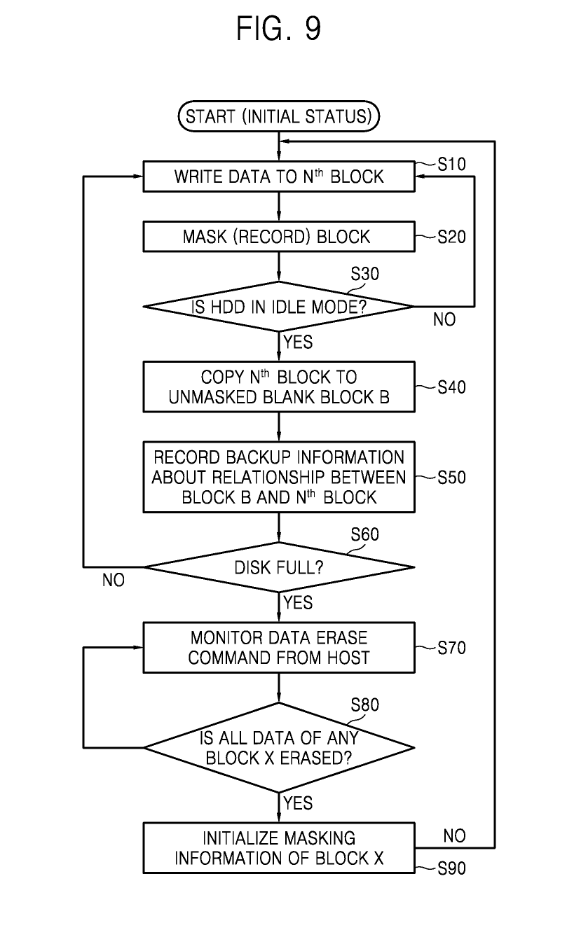

FIG. 9 is a flowchart for explaining the backup process of the storage device of FIG. 1 according to an exemplary embodiment. Referring to FIG. 9, the controller 110 may write data to the N-th block according to the command from a user or an OS (S10). Then, the controller 110 may mask (or record) that data is written to the N-th block, in a matching table (S20). When the storage device 100 supporting an automatic backup function enters the idle mode (S30-YES), the controller 110 may search for any one of blocks in the available region, where the user data is not written and copy data of Block N to Block B that is a searched block (S40). Matching information about the relationship between Block B and the N-th block may be recorded as described in FIGS. 3 through 8 (S50).

When the capacity of the storage medium 120 is full (S60-YES), the controller 110 monitors a data erase command received from the host 200 (S70). When data of a particular block X is all erased (S80), information written in relation to the block X may be initialized in the matching table (S90). The initialization may denote that the matching table is corrected to reflect the backup relation and/or the priority order after the block X is erased as described in FIG. 6 or 7.

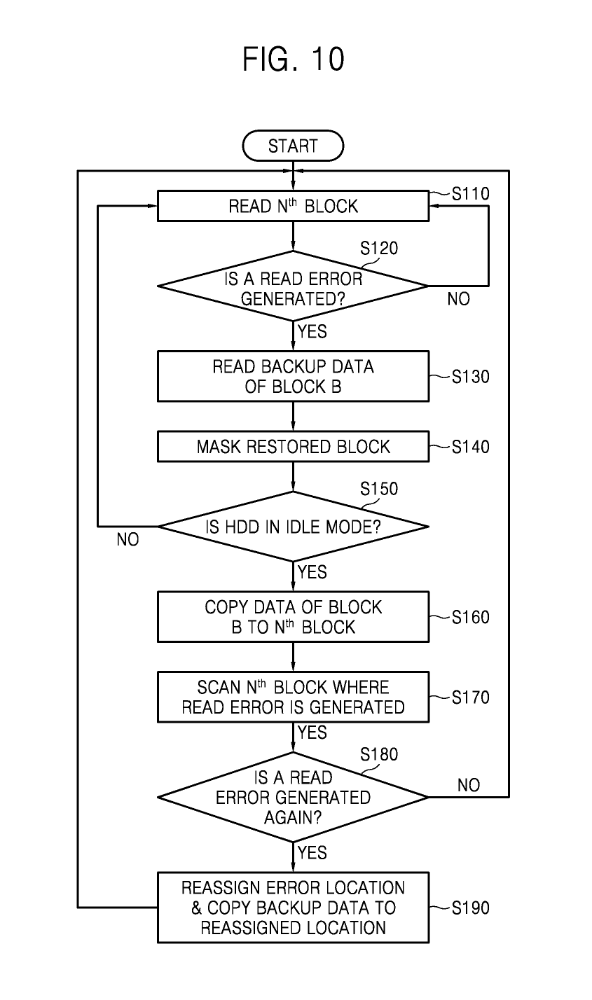

FIG. 10 is a flowchart for explaining a data restoration process performed by the storage device 100 of FIG. 1 according to an exemplary embodiment. Referring to FIG. 10, the controller 110 may read the N-th block (S110). When a read error is generated (S120-YES), the controller 110 determines a backup block of the N-th block, referring to the matching table. When the backup block of the N-th block is Block B, the controller 110 may avoid a read error by reading the backup data of Block B (S130). The controller 110 may write that the N-th block is a block to be restored, in the matching table and/or at a predetermined location (S140).

When the storage device 100 supporting an automatic backup function is in the idle mode (S150-YES), the N-th block that is indicated as a block to be restored is restored as the data of Block B is coped to the N-th block (S160). The controller 110 may scan whether a read error is generated in the N-th block (S170). When a read error is generated (S180-YES), it is determined that a defect is generated in a physical storage medium corresponding to the N-th block. In such a case, the location in the N-th block where the error is generated is reassigned and then backup data is copied to the reassigned location, thereby performing a defect process (S190).

The method to provide the storage device 100 supporting an automatic backup function according to the present inventive concept can also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the storage devices supporting an automatic backup function according to the exemplary embodiments, since the storage device automatically performs data backup in the idle mode of the storage device, reliability of the storage device may be improved without deteriorating performance of the storage device that is actually sensed by a user. Also, since the storage device does not previously assign a space for backup or the assigned space is not fixed, the space is dynamically utilized so that efficiency in use of the memory space may be improved. Furthermore, since data that is unnecessary or has a low necessity for backup is previously set and backup data is erased according to the type of data when the backup space is insufficient, the efficiency of backup may be improved.

While exemplary embodiments have been particularly shown and described, it will be understood that various changes in form and details may be made therein without departing from the spirit and scope of the following claims.

What is claimed is:

1. A storage device having an automatic backup function which is connected to a host apparatus to store user data, the storage device comprising:
a storage medium which stores the user data; and
a controller which controls data writing and reading of the storage medium,
wherein when the storage device is in an idle mode, the controller backs up at least a portion of the user data stored in the storage medium in an available region of the storage medium.

2. The storage device of claim 1, wherein the controller searches for a location in the storage medium where at least a portion of the user data is backed up and backs up the at least the portion of the user data at a searched location.

3. The storage device of claim 1, wherein the controller divides the storage medium into a plurality of blocks, and when the at least the portion of the user data is written to a first block of the plurality of blocks, the controller determines the first block to be a target backup block to be backed up and backs up the user data of the first block in a second block of the available region.

4. The storage device of claim 3, wherein the controller stores matching information indicating that the second block is a backup block of the first block in the storage medium or at least one of memories provided in the storage medium.

5. The storage device of claim 4, wherein the controller receives from the host a read command to read the first block, and when a read error is generated in the first block, the controller provides the host with backup data stored in the second block based on the matching information.

6. The storage device of claim 4, wherein, when a write command to write second user data to the second block is received from the host, the controller writes the second user data to the second block.

7. The storage device of claim 6, wherein the controller sets that the first block has a higher backup priority among target backup blocks.

8. The storage device of claim 4, wherein, when at least a partial area of the first block is determined to be defective, the controller reassigns the at least the partial area to another area of the storage medium and copies a backup area corresponding to the at least a partial area of the second block to the other area that is reassigned.

9. The storage device of claim 1, wherein the controller determines whether to backup at least a portion of the user data in the available region, or erases at least a portion of the user data that is backed up, based on a type of data of the at least the portion of the user data.

10. A storage device having an automatic backup function which is connected to a host apparatus to store user data, the storage device comprises:
a storage medium which stores the user data; and
a controller which controls data writing and reading of the storage medium,
wherein the controller divides the storage medium into a plurality of blocks, and when at least a portion of the user data is written to a first block of the plurality of blocks, the controller backs up the at least the portion of the user data of the first block in a second block that is an available region of the storage medium.

11. The storage device of claim 10, wherein the controller stores matching information indicating that the second block is a backup block of the first block in the storage medium or at least one of memories provided in the storage medium.

12. The storage device of claim 11, wherein the controller receives from the host a read command to read the first block, and when a read error is generated in the first block, the controller provides the host with backup data stored in the second block based on the matching information.

13. The storage device of claim 11, wherein, when a write command to write second user data to the second block is received from the host, the controller writes the second user data to the second block.

14. The storage device of claim 10, wherein, when at least a partial area of the first block is determined to be defective, the controller reassigns the at least the partial area to another area of the storage medium and copies a backup area corresponding to the at least the partial area of the second block to the other area that is reassigned.
